(19) United States
(12) Patent Application Publication
(10) Pub. No.: US 2026/0160298 A1
(43) Pub. Date: Jun. 11, 2026

(54) BEARING DEVICE

(71) Applicant: TOYOTA JIDOSHA KABUSHIKI KAISHA, Toyota-shi (JP)

(72) Inventors: Takushi FUJIOKA, Toyota-shi (JP); Ryuichi HASEGAWA, Nisshin-shi (JP)

(73) Assignee: TOYOTA JIDOSHA KABUSHIKI KAISHA, Toyota-shi (JP)

(21) Appl. No.: 19/312,915

(22) Filed: Aug. 28, 2025

(30) Foreign Application Priority Data
Dec. 9, 2024 (JP) 2024-214471

(51) Int. Cl. F16C 33/66

(52) U.S. Cl. CPC F16C 33/6681

(57) ABSTRACT

In the bearing device, a rolling bearing is attached to a housing portion of the housing. The rolling bearing of the bearing device includes an inner ring fixed to an outer peripheral surface of a shaft which is a rotation shaft, an outer ring fixed to the housing, a rolling element rolling between the inner ring and the outer ring, and a cage for holding a space between the rolling elements. In the bearing device, a discharge port for discharging the lubricating oil is provided in the housing portion. The bearing device discharges the lubricating oil from the discharge port to the center side of the inner ring rather than the outer periphery of the inner ring of the rolling bearing.

### CROSS-REFERENCE TO RELATED APPLICATION

This application claims priority to Japanese Patent Application No. 2024-214471 filed on Dec. 9, 2024. The disclosure of the above-identified application, including the specification, drawings, and claims, is incorporated by reference herein in its entirety.

### BACKGROUND

### 1. Technical Field

The present disclosure relates to a bearing device.

### 2. Description of Related Art

Japanese Unexamined Patent Application Publication No. 2018-087597 (JP 2018-087597 A) discloses a bearing device including an oil supply unit that discharges lubricating oil toward balls that are rolling elements of a rolling bearing.

### SUMMARY

When lubricating oil is supplied to a bearing device, when the supplied lubricating oil collides with rolling elements and a cage that are in rotational motion, a resistance force that hinders the rotational motion of the rolling elements and the cage is generated according to the speed of the lubricating oil. This resistance force reduces the driving force of a rotary shaft.

In order to address the above issue, an aspect provides a bearing device in which a rolling bearing is attached to a housing portion of a housing. The rolling bearing of the bearing device includes an inner ring fixed to an outer peripheral surface of a rotary shaft, an outer ring fixed to the housing, rolling elements that roll between the inner ring and the outer ring, and a cage that keeps intervals of the rolling elements.

In the bearing device, the housing portion is provided with a discharge port that discharges lubricating oil.
In the bearing device, the lubricating oil is discharged from the discharge port further to a center side of the inner ring than an outer periphery of the inner ring in the rolling bearing.

According to the bearing device described above, when lubricating oil is supplied to the rolling bearing, it is possible to suppress the lubricating oil colliding with the rolling elements and the cage and generating a resistance force that hinders the rotation of the rotary shaft.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view of a bearing device according to an embodiment;

FIG. 2 is a front view of the housing portion of the bearing device of FIG. 1 as viewed from the opening side of the housing portion;

FIG. 3 is a cross-sectional view showing a bearing device according to a modification; and

FIG. 4 is a cross-sectional view of a bearing device according to another modification.

### DETAILED DESCRIPTION OF EMBODIMENTS

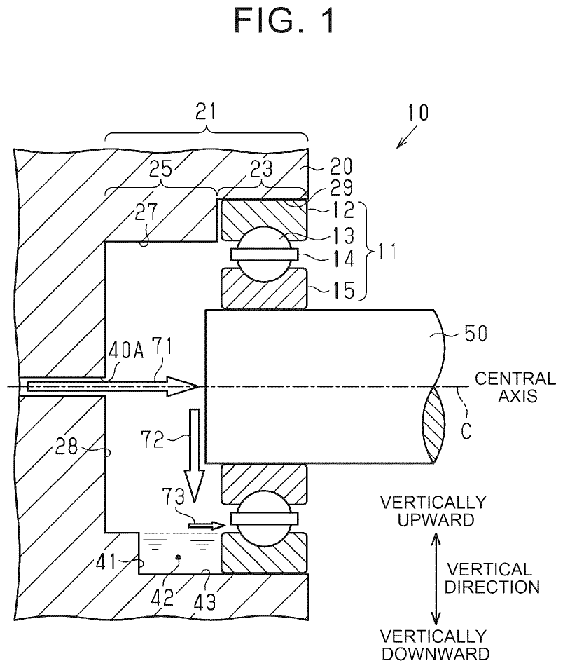

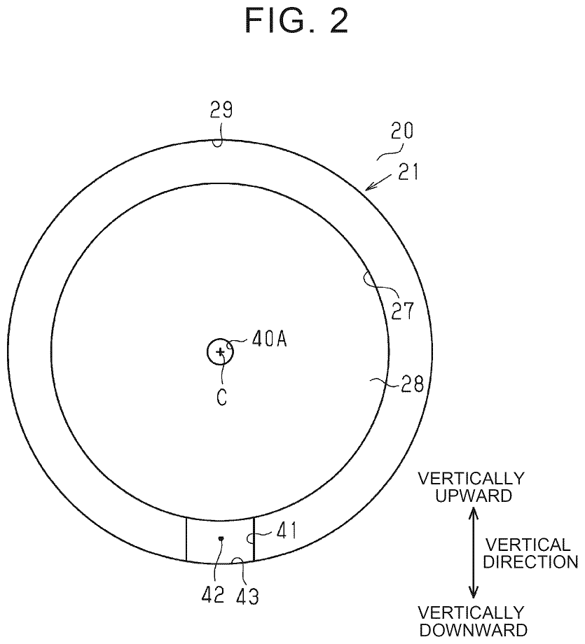

Hereinafter, a bearing device 10, which is an embodiment of the bearing device, will be described with reference to FIGS. 1 and 2. In FIG. 1, the central axis of the bearing device 10 is indicated by a dashed-dotted line as the central axis C. The central axis C extends horizontally. In FIG. 1 to FIG. 4, the central axis C is shown. In FIG. 1 to FIG. 4, the vertical direction is indicated by an arrow, and the vertical upper part and the vertical lower part are indicated.

### Configuration of the Bearing Device 10

FIG. 1 is a cross-sectional view of a bearing device 10 taken along a vertical plane along a central axis C. The bearing device 10 is provided, for example, in a transmission having a plurality of rotation shafts.

As shown in FIG. 1, the bearing device 10 supports an end portion of a shaft 50, which is one of the rotation shafts. The housing 20 of the bearing device 10 is provided with a housing portion 21. A rolling bearing 11 is accommodated in the housing portion 21. The bearing device 10 is part of a transmission. Therefore, the housing 20 of the bearing device 10 is a part of the case of the transmission.

As shown in FIG. 1, the housing portion 21 includes an accommodation hole 27 and an accommodation groove 29 provided in an opening of the accommodation hole 27. The receiving hole 27 is a circular hole provided in the housing 20.

The depth direction of the accommodation hole 27 coincides with the axial direction of the central axis C. The bottom surface 28 of the receiving hole 27 is orthogonal to the central axis C.

As shown in FIGS. 1 and 2, a receiving groove 29 is provided in the opening of the receiving hole 27. The diameter of the opening in the accommodation hole 27 is enlarged by the accommodation groove 29.

Hereinafter, a portion of the accommodation hole 27 closer to the bottom surface 28 than the accommodation groove 29 is referred to as a small diameter portion 25. A portion of the accommodation groove 29 in the accommodation hole 27 is referred to as a large diameter portion 23.

As shown in FIG. 1, the rolling bearing 11 includes an outer ring 12, a cage 14, an inner ring 15, and a plurality of rolling elements 13. The rolling bearing 11 is a ball bearing including a spherical rolling element 13.

As shown in FIG. 1, the inner ring 15 is fixed to the outer peripheral surface of the shaft 50. The outer ring 12 is fixed in the housing 20 in a state of being fitted into the accommodation groove 29.

Each rolling element 13 rolls between the inner ring 15 and the outer ring 12 while being in sliding contact with the inner ring 15 and the outer ring 12. The cage 14 maintains the interval between the rolling elements 13 and suppresses the bias of the rolling elements 13.

A central axis C indicated by a one-dot chain line in FIG. 1 is a central axis of the rolling bearing 11. That is, the central axis C is the central axis of the outer ring 12 and the inner ring 15 of the rolling bearing 11. The central axis C coincides with the rotational axis of the shaft 50. As shown in FIG. 1, the axial direction of the central axis C is perpendicular to the vertical direction. That is, the axial direction of the central axis C coincides with the horizontal direction. As described above, in the bearing device 10, the rolling bearing 11 is attached to the housing portion 21 in a direction in which the axial direction of the central axis C of the inner ring 15 coincides with the horizontal direction.

As shown in FIG. 1, the end portion of the shaft 50 fixed to the inner ring 15 of the rolling bearing 11 faces the bottom surface 28. As described above, the housing portion 21 is closed by the rolling bearing 11 fitted in the accommodation groove 29 and the end portion of the shaft 50.

As shown in FIGS. 1 and 2, a discharge port 40A for discharging the lubricant is provided on the bottom surface 28 of the accommodation hole 27. The discharge port 40A is provided at a position on the bottom surface 28 on the extension line of the central axis C of the shaft 50. The discharge port 40A is connected to an oil pump through an oil feed passage provided in the housing 20. The oil feed path connected to the discharge port 40A extends horizontally along the axis of the central axis C. Lubricating oil delivered from the oil pump is discharged from the discharge port 40A.

### Cutout Portion 41

As indicated by an arrow 71 in FIG. 1, the discharge port 40A discharges the lubricant toward the rotational center of the shaft 50 at the end portion of the shaft 50. As shown in FIG. 1, the housing portion 21 has a space having a circular cross section formed by the small-diameter portion 25, which is located closer to the discharge port 40A than the rolling bearing 11. The diameter of the small-diameter portion 25 is equal to the inner diameter of the outer ring 12.

As shown in FIGS. 1 and 2, the bearing device 10 is provided with a cutout portion 41 on the lower surface of the housing portion 21 40A the discharge port from the rolling bearing 11. The lower surface is a surface positioned vertically below the inner peripheral surface of the housing portion 21. The cutout portion 41 is connected to the accommodation groove 29 and is adjacent to the outer ring 12. The cutout portion 41 is a substantially rectangular cutout when viewed from the vertical upper side.

As shown in FIGS. 1 and 2, the position of the notched bottom surface 43, which is the bottom surface of the cutout portion 41, is the same position as the outer diameter of the outer ring 12 of the rolling bearing 11. That is, the depth of the cutout portion 41 is equal to the thickness of the outer ring 12.

### Operation of This Embodiment

The lubricating oil discharged from the discharge port 40A is stored in the oil reservoir 42, which is a part surrounded by the cutout portion 41 and the outer ring 12. In the bearing device 10, the cage 14 and the rolling elements 13 are positioned between the inner ring 15 and the outer ring 12. That is, the cage 14 and the rolling elements 13 are located radially outward with respect to the inner ring 15. In the bearing device 10, the discharged lubricating oil is discharged to the center side of the inner ring 15 rather than the outer periphery of the inner ring 15 of the rolling bearing 11, as indicated by an arrow 71 in FIG. 1. Therefore, the lubricant discharged from the discharge port 40A does not directly collide with the cage 14 and the rolling elements 13 located on the outer side of the inner ring 15. In the bearing device 10, the lubricating oil that has collided with the inner ring 15 or the shaft 50 and loses momentum is supplied to the cage 14 and the rolling elements 13.

### Effect of This Embodiment

(1) According to the bearing device 10, when lubricating oil is supplied to the rolling bearing 11, it is possible to suppress the lubricating oil colliding with the cage 14 and the rolling elements 13 and generating a resistance force that hinders the rotation of the shaft 50.

(2) The rolling bearing 11 of the bearing device 10 is mounted in the housing portion 21 in a direction in which the axial direction of the central axis C of the inner ring 15 coincides with the horizontal direction. The housing portion 21 has a space formed by a small-diameter portion 25 having a diameter equal to or smaller than the inner diameter of the outer ring 12 on the discharge port 40A of the rolling bearing 11. A cutout portion 41 is provided on the lower surface of the housing portion 21, which is a part of the wall surface of the space, closer to the discharge port 40A than the rolling bearing 11, and adjoins the outer ring 12. The notch bottom surface 43 is located radially outward of the outer ring 12 from the inner surface of the outer ring 12.

In the bearing device 10, as indicated by an arrow 71 in FIG. 1, the lubricating oil that has collided with the shaft 50 falls toward the lower surface of the housing portion 21 as indicated by an arrow 72 in FIG. 1. The dropped lubricating oil is stored in a cutout portion 41 provided on the lower surface of the housing portion 21. Therefore, in the bearing device 10, the fallen lubricating oil is unlikely to bounce back on the lower surface of the housing portion 21 and collide with the cage 14 and the rolling elements 13 as it is.

As indicated by an arrow 73 in FIG. 1, the lubricating oil stored in the oil reservoir 42 is supplied to the inside of the outer ring 12. The bearing device 10 lubricates the cage 14 and the rolling elements 13 by the weakened lubricating oil stored in the cutout portion 41.

According to the bearing device 10, when oil is supplied to the rolling bearing 11, the cage 14 and the rolling elements 13 can be appropriately lubricated while suppressing the high-speed lubricating oil bounced back on the lower surface of the housing portion 21 from colliding with the cage 14 and the rolling elements 13.

(3) The rolling bearing 11 of the bearing device 10 supports an end portion of the shaft 50. The housing portion 21 of the bearing device 10 is closed in a state in which the rolling bearing 11 is fitted in the accommodation groove 29 provided in the opening of the circular accommodation hole 27 provided in the wall surface of the housing 20 so that the end portion of the shaft 50 and the bottom surface 28 of the accommodation hole 27 face each other. In the housing portion 21 of the bearing device 10, the diameter of the small-diameter portion 25, which is a portion of the housing hole 27 closer to the bottom surface 28 side than the housing groove 29, in the housing hole 27 is smaller than or equal to the inner diameter of the outer ring 12 and larger than the outer diameter of the inner ring 15. The discharge port 40A of the bearing device 10 is provided on the bottom surface 28 of the accommodation hole 27, and discharges the lubricant toward the rotational center of the shaft 50 at the end portion of the shaft 50.

The resistance force acting when the discharged lubricating oil collides with the inner ring 15 or the shaft 50 increases as the lubricating oil collides with a position away from the rotation center of the inner ring 15 or the shaft 50. As indicated by an arrow 71 in FIG. 1, the bearing device 10 discharges the lubricating oil to the rotation center of the end portion of the shaft 50. Therefore, the resistance generated by the collision of the lubricating oil can be reduced as much as possible.

(4) In the bearing device 10, the diameter of the small-diameter portion 25, which is a portion of the housing hole 27 on the bottom surface 28 side, is equal to the inner diameter of the outer ring 12.

As indicated by an arrow 73 in FIG. 1, the bearing device 10 realizes the above-described effects by supplying the lubricating oil overflowing from the oil reservoir 42 to the inside of the outer ring 12.

### Example of Change

The present embodiment can be modified as follows. The present embodiment and the following modifications can be implemented in combination with each other within a technically consistent range.
In the bearing device 10, the discharge port 40A is provided at a position on an extension line of the central shaft C of the shaft 50 on the bottom surface 28. In the bearing device 10, the position of the discharge port provided on the bottom surface 28 is not limited to the above position. For example, the discharge port may be provided at a position deviated from a position on the bottom surface 28 on the extension line of the central axis C of the shaft 50 in any one of the up, down, left, and right directions on the bottom surface 28. Further, the discharge port may be provided within the range of the small-diameter portion 25 in the side surface of the accommodation hole 27.
The bearing device 10 discharges the lubricating oil toward the center of rotation of the shaft 50 at the end of the shaft 50. The discharge port may discharge the lubricating oil toward other than the rotation center of the shaft 50 as long as the lubricating oil is discharged from the discharge port to the center side of the inner ring 15 than the outer periphery of the inner ring 15 of the rolling bearing 11. For example, the discharge port may discharge the lubricating oil toward a position deviated from the rotation center of the shaft 50 in any of the up, down, left, and right directions.

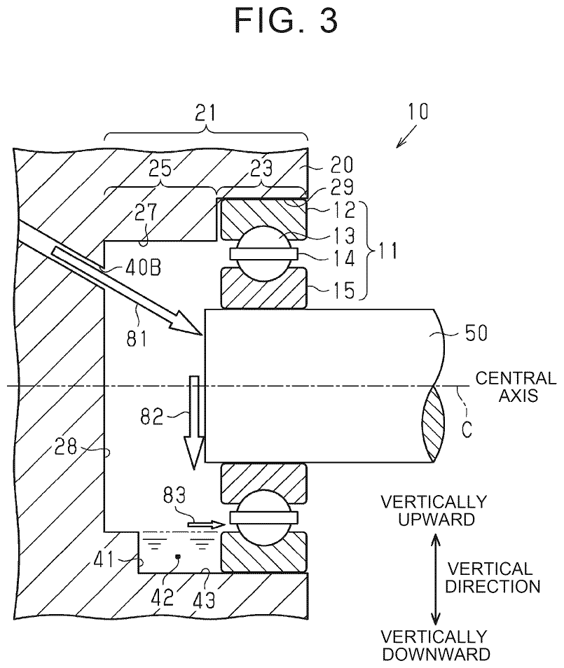

As an example, the bearing device 10 may discharge the lubricating oil toward a position shifted downward from the rotation center of the end portion of the shaft 50. In the bearing device 10, since the height at which the lubricating oil falls is reduced, the lubricating oil that collides with the inner ring 15 or the shaft 50 and falls due to gravity is less likely to rebound at the lower surface of the housing portion 21 or the liquid surface of the lubricating oil in the cutout portion 41. According to the bearing device 10, the lubricating oil splashed back by the lower surface of the housing portion 21 or the liquid surface of the lubricating oil in the cutout portion 41 is less likely to collide with the cage 14 and the rolling elements 13.
With reference to FIG. 3, a specific example of the bearing device 10 to which the above two modification examples are applied will be described. As shown in FIG. 3, in the bearing device 10 of the modification, the discharge port 40B is provided at a position vertically above the center of the bottom surface 28. As shown in FIG. 3, the discharge port 40B is provided so as to face obliquely downward.

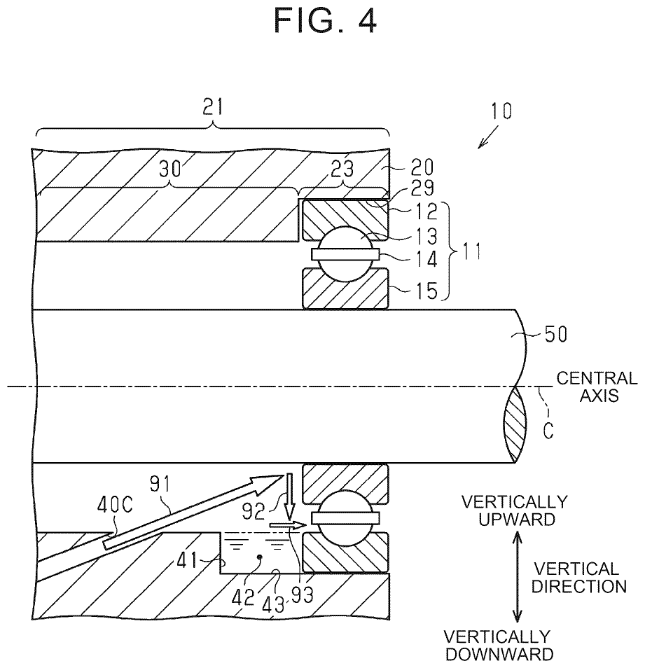

As indicated by an arrow 81 in FIG. 3, the lubricant is discharged from the discharge port 40B toward a position shifted upward from the rotational center of the end portion of the shaft 50. The lubricating oil colliding with the end portion of the shaft 50 falls toward the cutout portion 41 as indicated by an arrow 82 in FIG. 3. Thereafter, as indicated by an arrow 83 in FIG. 3, the lubricating oil is supplied from the cutout portion 41 to the inside of the outer ring 12.
The discharge port may discharge the lubricating oil toward the side surface of the inner ring 15 of the rolling bearing 11.
   In the bearing device 10, the diameter of the small-diameter portion 25 is equal to the inner diameter of the outer ring 12. The diameter of the small-diameter portion 25 of the bearing device 10 may not be equal to the inner diameter of the outer ring 12 as long as the diameter is smaller than or equal to the inner diameter of the outer ring 12 and larger than the outer diameter of the inner ring 15.
In the bearing device 10, the position of the cutout bottom surface 43 is the same as the position of the outer ring 12 in the radial direction of the rolling bearing 11. As long as the notch bottom surface 43 of the bearing device 10 is located radially outward of the outer ring 12 relative to the inner surface of the outer ring 12, the notch bottom surface 43 may be radially inward of the outer surface of the outer ring 12. By changing the position of the notch bottom surface 43, the amount of lubricating oil that can be stored in the oil reservoir 42 can be changed.
The bearing device 10 is a bearing that supports an end portion of the shaft 50. The bearing device 10 is not limited to a bearing that supports an end portion of the shaft 50.
   FIG. 4 is a schematic diagram illustrating a modified example in which the shaft 50 is inserted into the bearing device 10. As shown in FIG. 4, the housing portion 21 of the bearing device 10 according to the modified embodiment has a small-diameter portion 30 that is a space having a circular cross section on the discharge port 40C of the rolling bearing 11. A shaft 50 is inserted through the small-diameter portion 30. The diameter of the small-diameter portion 30 is equal to the inner diameter of the outer ring 12.

In the bearing device 10 according to the modification, the discharge port 40C is provided in the area of the small-diameter portion 30 on the lower surface of the housing portion 21. The discharge port 40C is provided on the lower surface so as to face obliquely upward. For example, as indicated by an arrow 91 in FIG. 4, the discharge port 40C discharges the lubricant from the discharge port 40C toward the side surface of the inner ring 15 40C the discharge port. The lubricating oil that has collided with the side surface of the inner ring 15 falls toward the cutout portion 41 as indicated by an arrow 92 in FIG. 4. Thereafter, as indicated by an arrow 93 in FIG. 4, the lubricating oil is supplied from the cutout portion 41 to the inside of the outer ring 12.
The diameter of the small diameter portion 30 of the bearing device 10 of the modification may not be equal to the inner diameter of the outer ring 12. The diameter of the small-diameter portion 30 may be equal to or smaller than the inner diameter of the outer ring 12.

What is claimed is:

1. A bearing device in which a rolling bearing is attached to a housing portion of a housing, the rolling bearing including an inner ring fixed to an outer peripheral surface of a rotary shaft, an outer ring fixed to the housing, rolling elements that roll between the inner ring and the outer ring, and a cage that keeps intervals of the rolling elements, wherein:
the housing portion is provided with a discharge port that discharges lubricating oil; and
the lubricating oil is discharged from the discharge port further to a center side of the inner ring than an outer periphery of the inner ring in the rolling bearing.

2. The bearing device according to claim 1, wherein:
the rolling bearing is attached to the housing portion in such a direction that an axial direction of a central axis of the inner ring coincides with a horizontal direction;
the housing portion has a space with a circular cross section having a diameter that is equal to or less than an inside diameter of the outer ring further on a side of the discharge port than the rolling bearing;
a cutout portion is provided adjacent to the outer ring in a lower surface of the housing portion, as a part of wall surfaces of the space, further on the side of the discharge port than the rolling bearing; and
a bottom surface of the cutout portion is located further on a radially outer side of the outer ring than an inner surface of the outer ring.

3. The bearing device according to claim 1, wherein:
the rolling bearing supports an end portion of the rotary shaft;
the housing portion is closed in a state in which the rolling bearing is fitted in a housing groove provided at an opening portion of a housing hole in a circular shape provided in a wall surface of the housing, such that the end portion of the rotary shaft and a bottom surface of the housing hole face each other;
a diameter of a portion of the housing hole further on a side of the bottom surface of the housing hole than the housing groove is equal to or less than an inside diameter of the outer ring and larger than an outside diameter of the inner ring; and
the discharge port is provided in the bottom surface of the housing hole, and discharges the lubricating oil toward a rotation center of the rotary shaft at the end portion of the rotary shaft.

4. The bearing device according to claim 3, wherein the diameter of the portion of the housing hole on the side of the bottom surface is equal to the inside diameter of the outer ring.

5. The bearing device according to claim 3, wherein the discharge port is provided in the bottom surface of the housing hole at a position on an extension line of a central axis of the rotary shaft.
